(19) United States
(12) Patent Application Publication
(10) Pub. No.: US 2025/0004647 A1
(43) Pub. Date: Jan. 2, 2025

(54) RELIABILITY IMPROVEMENTS USING MEMORY DIE BINNING

(71) Applicant: Micron Technology, Inc., Boise, ID (US)

(72) Inventors: Ying Yu Tai, Mountain View, CA (US); Jun Wan, San Jose, CA (US); Seungjune Jeon, Santa Clara, CA (US); Zhenming Zhou, San Jose, CA (US); Jiangli Zhu, San Jose, CA (US)

(21) Appl. No.: 18/677,578

(22) Filed: May 29, 2024

Related U.S. Application Data
(60) Provisional application No. 63/524,147, filed on Jun. 29, 2023.

(51) Int. Cl. G06F 3/06

(52) U.S. Cl. CPC G06F 3/0616; G06F 3/0629; G06F 3/0679

(57) ABSTRACT

A processing device analyzes one or more property and capability characteristics of a plurality of memory devices produced in a development process executed by a memory device development system and identifies respective subsets of the plurality of memory devices having property and capability characteristics that meet respective standards associated with a plurality of different use cases. The processing device further allocates the respective subsets to groups of memory devices corresponding to the different use cases.

### RELATED APPLICATIONS

This application claims the benefit of U.S. Provisional Patent Application No. 63/524,147, filed Jun. 29, 2023, the entire contents of which are hereby incorporated by reference herein.

### TECHNICAL FIELD

Embodiments of the disclosure relate generally to memory sub-systems, and more specifically, relate to reliability improvements using memory die binning in the production of memory sub-systems.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A is a block diagram illustrating a memory device development system in accordance with some embodiments of the present disclosure.

FIG. 1B illustrates a timeline for a memory device development process in accordance with some embodiments of the present disclosure.

FIG. 1C illustrates a plot of the number of produced memory devices having a certain level of property and capability characteristics in accordance with some embodiments of the present disclosure.

FIG. 2 illustrates an example computing system that includes a memory sub-system in accordance with some embodiments of the present disclosure.

FIG. 3 is a flow diagram of an example method of using memory die binning in the production of memory sub-systems to improve reliability in accordance with some embodiments of the present disclosure.

FIG. 4 is a flow diagram of an example method of utilizing redundant columns on a memory device to improve the error correction capability in a memory sub-system in accordance with some embodiments of the present disclosure.

FIG. 5 is a flow diagram of an example method of utilizing adaptive media scan thresholds to improve the latent read disturb tolerance in a memory sub-system in accordance with some embodiments of the present disclosure.

FIG. 6 is a block diagram of an example computer system in which embodiments of the present disclosure may operate.

### DETAILED DESCRIPTION

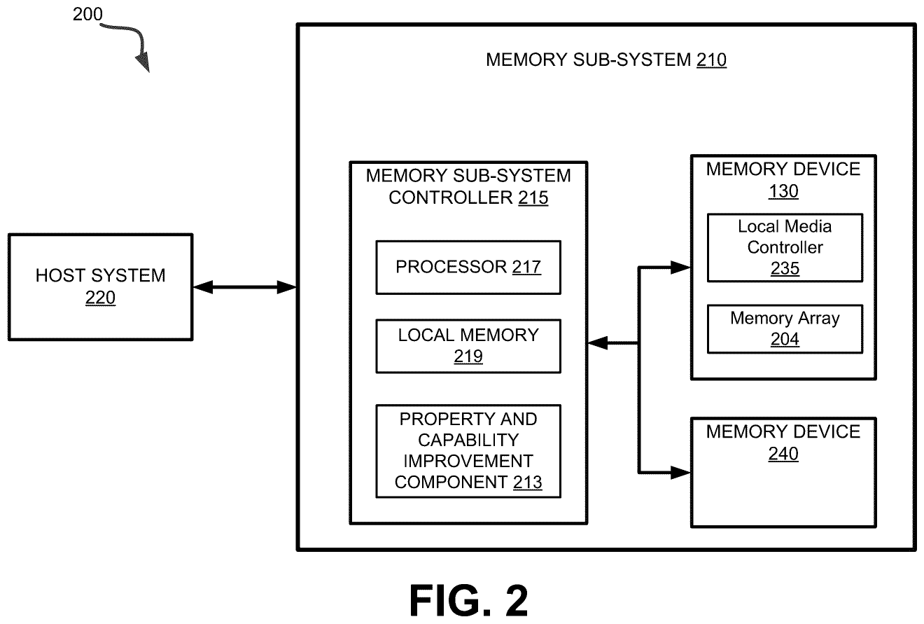

Aspects of the present disclosure are directed to reliability improvements using memory die binning in the production of memory sub-systems. A memory sub-system can be a storage device, a memory module, or a hybrid of a storage device and memory module. Examples of storage devices and memory modules are described below in conjunction with FIG. 2. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “2”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

One example of a memory sub-system is a solid-state drive (SSD) that includes one or more non-volatile memory devices (e.g., memory dies) and a memory sub-system controller to manage the non-volatile memory devices. The memory sub-systems can ultimately be sold to a variety of different customers and/or be intended for implementation in a variety of different uses cases. For example, some memory sub-systems can be used in client systems that have relatively light workloads and are not subjected to extreme operating conditions. Other memory sub-systems, however, are intended for mobile applications, or enterprise datacenters, and are likely to face heavier workloads and potentially extreme operating conditions. These different customers and different uses cases may prioritize different features and property and capability characteristics of the memory sub-systems. Accordingly, the memory devices developed for these memory sub-systems, even if based on the same underlying technology, may need to meet different standards for various property and capability characteristics. Certain property and capability characteristics which may be of varying importance include reliability, write performance, data retention, read disturb effect, latent read disturb effect, endurance, or others. In general, however, the majority of these property and capability characteristics can be represented by the read window budget (RWB) present in a given memory device. The read window budget is associated with the read window size (i.e., a size measured in volts, representing the distance, on a voltage scale, between a threshold voltage distribution of memory cells associated with one programming level and a threshold voltage distribution of memory cells associated with a subsequent programming level) on the memory device. The read window budget refers to the cumulative value of the read windows (i.e., the total size of all the read windows of a set of memory cells), and generally is proportional to the properties and capabilities of the memory device, such that a larger read window budget is indicative of the memory device's ability to satisfy stricter requirements for the various property and capability characteristics described above.

A certain type of memory device, for example, can include an array of memory cells configured as triple-level cell (TLC) memory (i.e., each cell is configured to store three bits of information). In other examples, the memory cells can be configured as other types of memory, such as single-level cell (SLC) memory, multi-level cell (MLC) memory, quad-level cell (QLC) memory, 3.5 bit memory, 4.5 memory, etc. During the development process, for example, there is an intrinsic improvement over time in the property and capability characteristics, and thus in the read window budget, of such a TLC memory device. Due to design changes, process refinements, and other factors, the read window budget of the produced memory devices can improve incrementally month-by-month. Thus, the memory devices produced at the beginning of the technology development cycle may have a read window budget that satisfies the more relaxed standards for memory devices intended for certain use cases, such as client systems. As the incremental improvements take time, however, it may take many months or even years to adequately improve the read window budget of the produced memory devices to meet the relatively strict standards associated with other use cases, such as mobile applications, enterprise datacenters, automotive applications, industry systems, or removable storage devices.

Aspects of the present disclosure address the above and other deficiencies by utilizing memory die binning to realize reliability improvements in the production of memory sub-systems. In one embodiment, at the beginning of the memory device development process, the property and capability characteristics of the majority of produced memory devices may be relatively low, as described above. Given the intrinsic die-to-die variation between memory devices, while the majority of produced memory devices may have property and capability characteristics that meet the lower standards associated with certain use cases, there may be a certain portion of the memory devices with characteristics that meet the higher standards of other use cases. Accordingly, this portion of the memory devices can be identified and made available for the user cases with higher property and capability standards, even early on in the memory device development process. In one embodiment, processing logic analyzes the property and capability characteristics of the memory devices produced at each stage of the development process, identifies respective subsets of the memory devices having property and capability characteristics that meet the respective standards associated with a number of different use cases, and allocates the respective subsets to groups (i.e., bins) of memory devices corresponding to the different use cases. Although in the early stages of the development process, only a small percentage of the produced memory devices may have property and capability characteristics that meet the stricter standards of certain use cases, the processing logic can take additional action to improve the property and capability characteristics of the produced memory devices, potentially allowing certain memory devices to satisfy the standards of higher-level use cases and be allocated to different groups. For example, the processing logic can enable a memory sub-system controller of the SSDs with which the produced memory devices will be associated to utilize redundant columns on the memory devices to improve the error correction capability in the memory sub-system and/or utilize adaptive media management features (e.g., adaptive scan thresholds) based on the quality of dies from the fabrication process and/or in-filed die quality calibration to improve latent read disturb tolerance in the memory sub-system.

Advantages of the approach described herein includes, but is not limited to, improvements in the memory device development process. For example, by allocating produced memory devices to different use cases at each stage of the development process, and improving the property and capability characteristics of those memory devices through the additional actions described herein, memory devices can be made available for those use cases having stricter standards significantly earlier than they otherwise would have been. This can reduce complexity in the memory device development process, as well as improve reliability and performance of the produced memory devices.

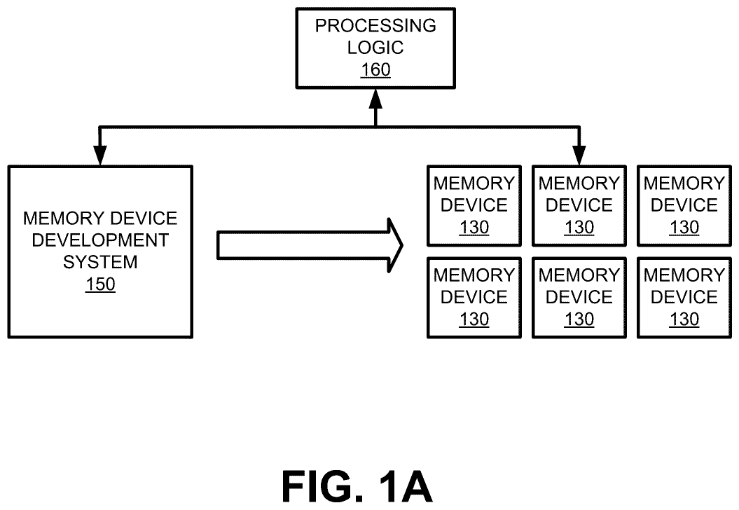

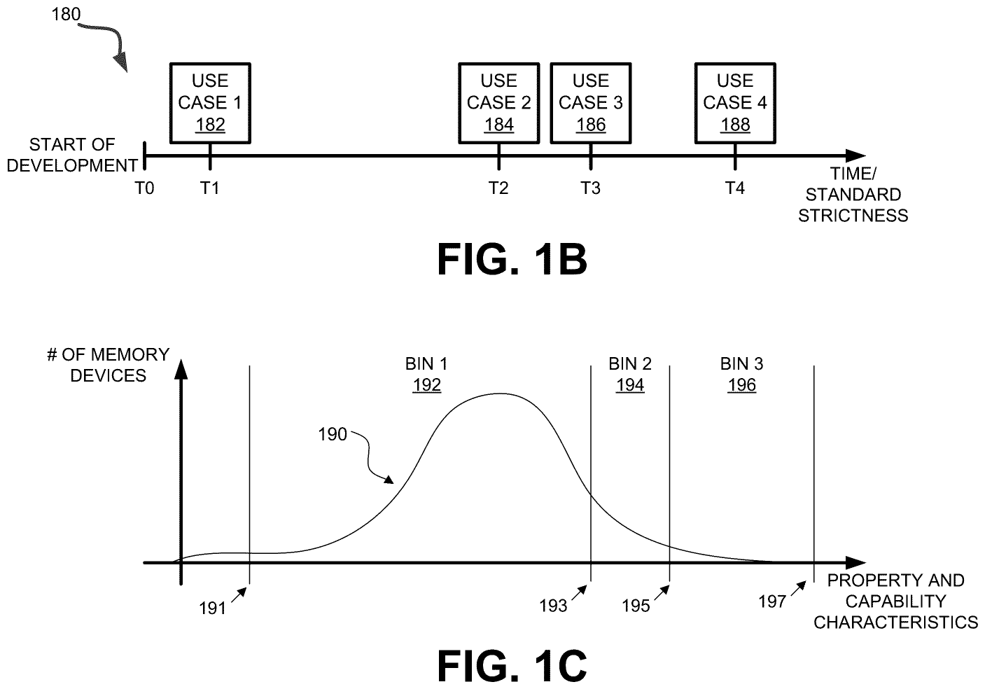

FIG. 1A is a block diagram illustrating a memory device development system 150. The memory device development system 150 can include any combination of design tools and processing tools used to develop and manufacture non-volatile memory devices, such as memory devices 130. Some examples of non-volatile memory devices (e.g., memory devices 130) include not-and (NAND) type flash memory and write-in-place memory, such as three-dimensional cross-point (“3D cross-point”) memory. NAND type flash memory can include, for example, two-dimensional NAND (2D NAND) and three-dimensional NAND (3D NAND). The memory devices 130 can be developed for use in memory sub-systems (e.g., solid-state drives), as will be described in more detail below with respect to FIG. 2.

As described above, the memory sub-systems including memory devices 130, or even just memory devices 130 themselves, can be sold to a variety of different customers and/or be intended for implementation in a variety of different uses cases. These use cases may have different standards for various property and capability characteristics, with some uses cases having more relaxed standards and others having stricter standards. FIG. 1B illustrates a timeline 180 for a memory device development process, such as can be performed by memory device development system 150. During the development process, there is an intrinsic improvement over time in the property and capability characteristics of the produced memory devices 130. Due to design changes, process refinements, and other factors associated with development system 150, the property and capability characteristics of the produced memory devices 130 can improve incrementally month-by-month. For example, the memory device development process may begin at time TO, and after a first amount of time T1 has passed, the produced memory devices 130 may have property and capability characteristics that meet the standards of use case 1 182. Use case 1 182 can include, for example, client systems that have relatively light workloads and are not subjected to extreme operating conditions. After a second amount of time T2 has passed, the produced memory devices 130 may have property and capability characteristics that meet the standards of use case 2 184. Use case 2 184 can include, for example, mobile applications that may be subjected to more extreme operating conditions, for example, and thus has stricter standards for property and capability characteristics. After a third amount of time T3 has passed, the produced memory devices 130 may have property and capability characteristics that meet the standards of use case 3 186. Use case 3 186 can include, for example, enterprise datacenters that that have higher workloads, for example, and thus has still stricter standards for property and capability characteristics. After a fourth amount of time T4 has passed, the produced memory devices 130 may have property and capability characteristics that meet the standards of use case 4 188. Use case 4 188 can include, for example, automotive applications that have even stricter standards for property and capability characteristics.

Referring again to FIG. 1A, processing logic 160 can be connected to memory device development system 150 and the produced memory devices can also be connected to processing logic 160. Processing logic 160 can represent any suitable processing device, such as a microprocessor, a central processing unit, computing software, a memory tester, or the like. More particularly, the processing logic 160 can include a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing logic 160 can also be one or more special-purpose processing devices such as an application specific integrated circuit (ASIC), a field programmable gate array (FPGA), a digital signal processor (DSP), network processor, or the like. The processing logic 160 can be configured to execute instructions for performing the operations and steps discussed herein, including for example, memory die binning.

In one embodiment, the processing logic 160 analyzes the property and capability characteristics of the memory devices 130 produced at each stage of the development process and identifies respective subsets of the memory devices 130 having property and capability characteristics that meet the respective standards associated with the different use cases 182-188. For example, at time T1, the processing logic 160 can perform any appropriate measurements, tests, scans, or other analyses to determine one or more representative property and capability characteristics of the memory devices 130 produced at that stage of the development process. In one embodiment, the processing logic 160 can determine the read window budget (RWB) of the memory devices. In other embodiments, the processing logic 160 can determine other property and capability characteristics, such as reliability, write performance, data retention, read disturb effect, latent read disturb effect, endurance, a number of blocks/pages available to a user, or a number of bitlines/columns available to the user, or others.

Near the beginning of the memory device development process (e.g., at time T1), the property and capability characteristics of the majority of produced memory devices 130 may be relatively low, and may for example, satisfy the more relaxed standards of use case 1 182. This is illustrated in FIG. 1C which includes a plot 190 of the number of produced memory devices having a certain level of property and capability characteristics at time T1. As shown, the majority of the produced memory devices 130 have a level of property and capability characteristics (e.g., RWB) that are above the threshold level 191, which is the minimum standard of property and capability characteristics for use case 1 182. Given the intrinsic die-to-die variation between memory devices, even at time T1, there may be a certain portion of the produced memory devices 130 with property and capability characteristics that meet the higher standards of other use cases. For example, a certain number of produced memory devices 130, as shown by curve 190, have a level of property and capability characteristics that are above the threshold level 193, which is the minimum standard of property and capability characteristics for use case 2 184, and even some that are above the threshold level 195, which is the minimum standard of property and capability characteristics for use case 3 186. In one embodiment, the processing logic 160 can identify the respective subsets of the memory devices 130 having property and capability characteristics that meet the respective standards associated with the different use cases 182-188 and allocate the respective subsets to groups (i.e., bins) of memory devices corresponding to the different uses cases. For example, the processing logic 160 can allocate the subset of memory devices having property and capability characteristics between the threshold levels 191 and 193 to bin 1 192 corresponding to use case 1 182, the subset of memory devices having property and capability characteristics between the threshold levels 193 and 195 to bin 2 194 corresponding to use case 2 184, and the subset of memory devices having property and capability characteristics between the threshold levels 195 and 197 to bin 3 196 corresponding to use case 3 186. Depending on the embodiment, there can be some other number of uses cases, some other number of bins, different threshold levels, and/or different property and capability characteristics that are considered.

Although in the early stages of the development process, only a small percentage of the produced memory devices 130 may have property and capability characteristics that meet the stricter standards of certain use cases (e.g., use cases 184-188), the processing logic 160 can take additional action to improve the property and capability characteristics of the produced memory devices 130, potentially allowing certain memory devices 130 to satisfy the standards of higher-level use cases and be allocated to different groups. This can increase the number of produced memory devices 130, as shown by curve 190, that have a level of property and capability characteristics that are above the threshold level 193 or the threshold level 195, even at time T1. For example, the processing logic 160 can enable a memory sub-system controller of the SSDs with which the produced memory devices 130 will be associated to utilize redundant columns on the memory devices to improve the error correction capability in the memory sub-system and/or utilize adaptive media scan thresholds to improve latent read disturb tolerance in the memory sub-system, as will be described in more detail below.

FIG. 2 illustrates an example computing system 200 that includes a memory sub-system 220 in accordance with some embodiments of the present disclosure. The memory sub-system 220 can include media, such as one or more volatile memory devices (e.g., memory device 240), one or more non-volatile memory devices (e.g., one or more memory device(s) 130), or a combination of such.

A memory sub-system 220 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 200 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 200 can include a host system 220 that is coupled to one or more memory sub-systems 220. In some embodiments, the host system 220 is coupled to different types of memory sub-system 220. FIG. 2 illustrates one example of a host system 220 coupled to one memory sub-system 220. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 220 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 220 uses the memory sub-system 220, for example, to write data to the memory sub-system 220 and read data from the memory sub-system 220.

The host system 220 can be coupled to the memory sub-system 220 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 220 and the memory sub-system 220. The host system 220 can further utilize an NVM Express (NVMe) interface to access the memory components (e.g., the one or more memory device(s) 130) when the memory sub-system 220 is coupled with the host system 220 by the PCIe interface. The physical host interface can provide an interface for passing control, address, data, and other signals between the memory sub-system 220 and the host system 220. FIG. 2 illustrates a memory sub-system 220 as an example. In general, the host system 220 can access multiple memory sub-systems via a same communication connection, multiple separate communication connections, and/or a combination of communication connections.

The memory devices 130, 240 can include any combination of the different types of non-volatile memory devices and/or volatile memory devices. The volatile memory devices (e.g., memory device 240) can be, but are not limited to, random access memory (RAM), such as dynamic random access memory (DRAM) and synchronous dynamic random access memory (SDRAM).

Some examples of non-volatile memory devices (e.g., memory device(s) 130) include not-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 225 (or controller 225 for simplicity) can communicate with the memory device(s) 130 to perform operations such as reading data, writing data, or erasing data at the memory devices 130 and other such operations. The memory sub-system controller 225 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 225 can be a microcontroller, special purpose logic circuitry (e.g., a field programmable gate array (FPGA), an application specific integrated circuit (ASIC), etc.), or other suitable processor.

The memory sub-system controller 225 can include a processor 227 (e.g., a processing device) configured to execute instructions stored in a local memory 229. In the illustrated example, the local memory 229 of the memory sub-system controller 225 includes an embedded memory configured to store instructions for performing various processes, operations, logic flows, and routines that control operation of the memory sub-system 220, including handling communications between the memory sub-system 220 and the host system 220.

In some embodiments, the local memory 229 can include memory registers storing memory pointers, fetched data, etc. The local memory 229 can also include read-only memory (ROM) for storing micro-code. While the example memory sub-system 220 in FIG. 2 has been illustrated as including the memory sub-system controller 225, in another embodiment of the present disclosure, a memory sub-system 220 does not include a memory sub-system controller 225, and can instead rely upon external control (e.g., provided by an external host, or by a processor or controller separate from the memory sub-system).

In general, the memory sub-system controller 225 can receive commands or operations from the host system 220 and can convert the commands or operations into instructions or appropriate commands to achieve the desired access to the memory device(s) 130. The memory sub-system controller 225 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 225 can further include host interface circuitry to communicate with the host system 220 via the physical host interface. The host interface circuitry can convert the commands received from the host system into command instructions to access the memory device(s) 130 as well as convert responses associated with the memory device(s) 130 into information for the host system 220.

The memory sub-system 220 can also include additional circuitry or components that are not illustrated. In some embodiments, the memory sub-system 220 can include a cache or buffer (e.g., DRAM) and address circuitry (e.g., a row decoder and a column decoder) that can receive an address from the memory sub-system controller 225 and decode the address to access the memory device(s) 130.

In some embodiments, the memory device(s) 130 include local media controllers 235 that operate in conjunction with memory sub-system controller 225 to execute operations on one or more memory cells of the memory device(s) 130. An external controller (e.g., memory sub-system controller 225) can externally manage the memory device 130 (e.g., perform media management operations on the memory device(s) 130). In some embodiments, a memory device 130 is a managed memory device, which is a raw memory device (e.g., memory array 204) having control logic (e.g., local controller 235) for media management within the same memory device package. An example of a managed memory device is a managed NAND (MNAND) device. Memory device(s) 130, for example, can each represent a single die having some control logic (e.g., local media controller 235) embodied thereon. In some embodiments, one or more components of memory sub-system 220 can be omitted.

In one embodiment, the memory sub-system 220 includes a property and capability improvement component 213 that can perform a variety of operations to improve the property and capability characteristics of memory device 130 and/or memory sub-system 210. For example, processing logic 160 can configure property and capability improvement component 213 to utilize redundant columns on the memory device 130 to improve the error correction capability in the memory sub-system 210, to utilize adaptive media scan thresholds to improve latent read disturb tolerance in the memory sub-system 210, or any number of other property and capability improvement operations, as will be described in more detail below.

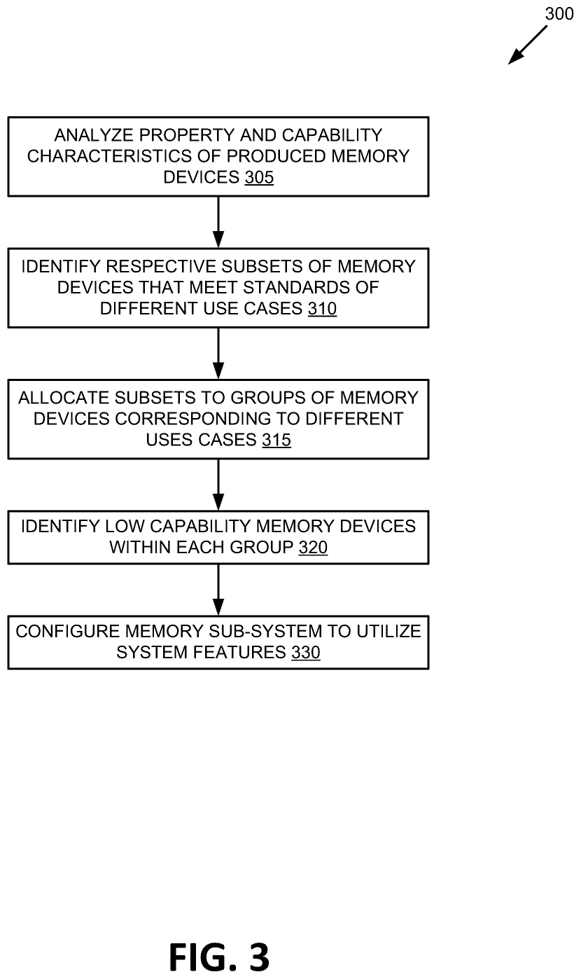

FIG. 3 is a flow diagram of an example method of using memory die binning in the production of memory sub-systems to improve reliability in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by processing logic 160 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing logic (e.g., processing logic 160) analyzes one or more property and capability characteristics of a plurality of memory devices, such as memory devices 130, produced in a development process executed by a memory device development system 150. In one embodiment, the development process includes a plurality of stages, where the memory devices 130 produced at each stage have improved property and capability characteristics relative to a previous stage. In one embodiment, the processing logic 160 analyzes the property and capability characteristics of the memory devices 130 produced at each stage of the development process such as by performing any appropriate measurements, tests, scans, or other analyses to determine one or more representative property and capability characteristics of the memory devices 130 produced at that stage of the development process. In one embodiment, the processing logic 160 can determine the read window budget (RWB) of the memory devices. In other embodiments, the processing logic 160 can determine other property and capability characteristics, such as one or more of endurance, data retention capability, read disturb tolerance, or latent read disturb tolerance of the plurality of memory devices.

At operation 310, the processing logic identifies respective subsets of the plurality of memory devices having property and capability characteristics that meet respective standards associated with a plurality of different use cases. These respective standards include a respective minimum level of properties and capabilities associated with each of the plurality of different uses cases. The different uses cases can include, for example, one or more of client systems, mobile applications, enterprise data centers, automotive applications, industry systems, or removable storage devices (e.g., SD or MicroSD cards). As the property and capability characteristics of the produced memory devices 130 generally improve over time, near the beginning of the memory device development process (e.g., at time T1), the property and capability characteristics of the majority of produced memory devices 130 may be relatively low, and may for example, satisfy the more relaxed standards of use case 1 182. As shown in FIG. 1C, the majority of the produced memory devices 130 have a level of property and capability characteristics (e.g., RWB) that are above the threshold level 191, which is the minimum standard of property and capability characteristics for use case 1 182. Given the intrinsic die-to-die variation between memory devices, even at time T1, there may be a certain portion of the produced memory devices 130 with property and capability characteristics that meet the higher standards of other use cases. For example, a certain number of produced memory devices 130, as shown by curve 190, have a level of property and capability characteristics that are above the threshold level 193, which is the minimum standard of property and capability characteristics for use case 2 184, and even some that are above the threshold level 195, which is the minimum standard of property and capability characteristics for use case 3 186. Processing logic can identify the subsets of the produced memory devices that meet each respective minimum standard of performance.

At operation 315, the processing logic allocates the respective subsets to groups of memory devices corresponding to the different use cases 182-188. For example, the processing logic 160 can allocate the subset of memory devices having property and capability characteristics between the threshold levels 191 and 193 to bin 1 192 corresponding to use case 1 182, the subset of memory devices having property and capability characteristics between the threshold levels 193 and 195 to bin 2 194 corresponding to use case 2 184, and the subset of memory devices having property and capability characteristics between the threshold levels 195 and 197 to bin 3 196 corresponding to use case 3 186. Depending on the embodiment, there can be some other number of uses cases, some other number of bins, different threshold levels, and/or different property and capability characteristics that are considered.

At operation 320, the processing logic identifies low capability memory devices within each group of memory devices. In one embodiment, the evaluation of the property and capability characteristics is performed during the factory manufacturing process. This evaluation can be done, for example, on a sample part (e.g., a sample block) of each memory device based on some predefined stress tests and measurements. Optionally, this evaluation can be also done during the normal product operation after the shipment of the products so that more accurate evaluations can be made and the original evaluation from the factory manufacturing process can be updated as needed.

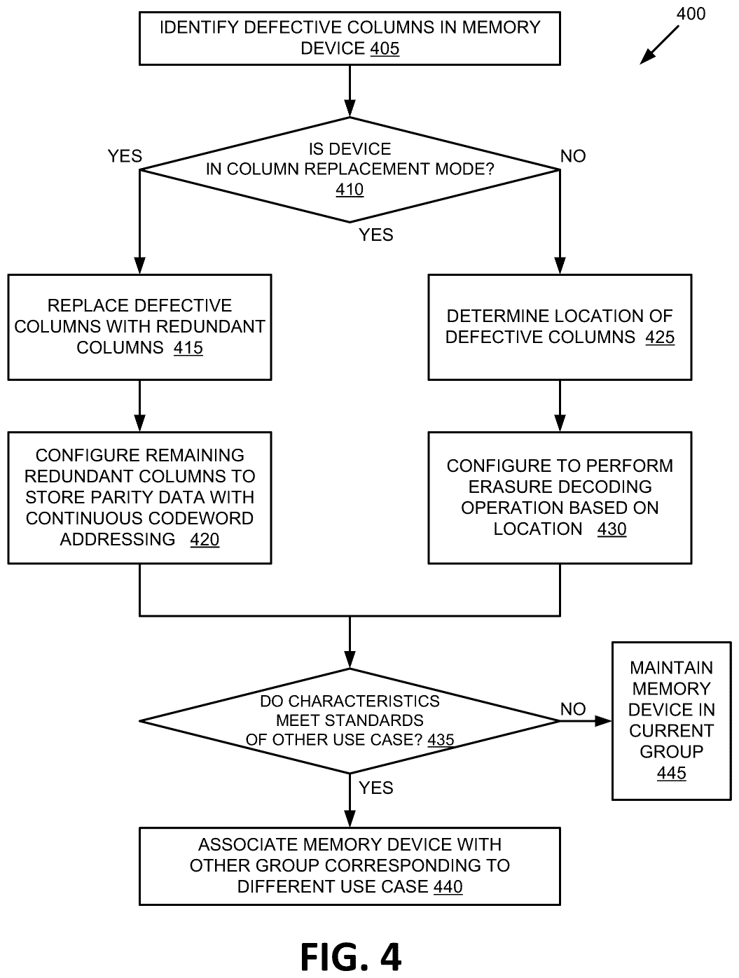

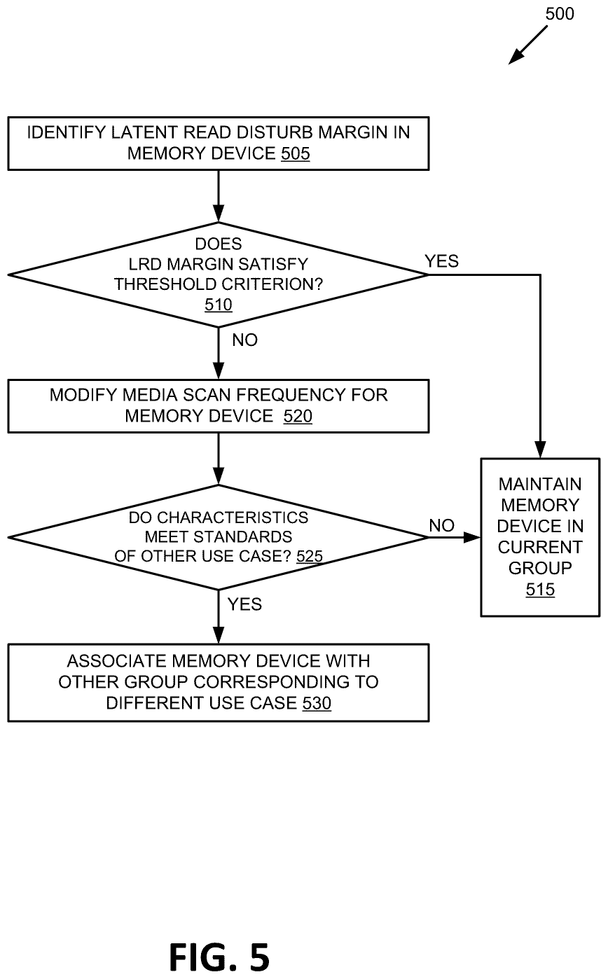

At operation 330, the processing logic configures a memory sub-system controller 215 of a memory sub-system 210 comprising one or more of the memory devices 130, such as those identified as low capability memory devices, to utilize certain system features. For example, the processing logic can issue one or more configuration commands or other instructions to the memory sub-system controller 215 to cause the memory sub-system controller 215 to utilize one or more redundant bitlines of the memory device to replace one or more defective bitlines or to utilize an adaptive media scan threshold for the memory device. Additional details with respect to these system features are provided below with respect to FIG. 4 and FIG. 5.

FIG. 4 is a flow diagram of an example method of utilizing redundant columns on a memory device to improve the error correction capability in a memory sub-system in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by property and capability improvement component 213 of FIG. 2 in response to configuration by processing logic 160 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing logic (e.g., property and capability improvement component 213) identifies one or more defective columns (e.g., bitlines) in a memory device, such as memory device 130. For example, in response to configuration commands/instructions received from processing logic 160, property and capability improvement component 213 can perform an analysis to identify any defective columns. The memory device 130 can include an array of memory cells 204 arranged in columns (e.g., bitlines) and rows (e.g., wordlines). The intersection of a bitline and wordline constitutes the address of a memory cell. In one embodiment, the property and capability improvement component 213 sequentially activates each bitline, while other bitlines remain disabled, and observes the behavior during sample operations performed on the activated bitline. If the bitline behavior does not match expectations, the property and capability improvement component 213 can determine that the bitline is defective. Property and capability improvement component 213 can perform a similar process for each bitline until all have been tested.

At operation 410, the processing logic determines whether the memory device 130 is configured in a column replacement mode. In one embodiment, the memory device 130 includes a memory array 204 including a number of columns (e.g., bitlines). In one embodiment, a first portion of the columns (e.g., 4 kilobytes) can be designated as regular columns and used to store host data at the corresponding memory cells. A second portion of the columns (e.g., 192 bytes) can be designated as redundant columns which can be used to replace defective columns in the first portion, if the memory device 130 is so configured. Depending on the embodiment, the memory device 130 can be configured (e.g., by virtue of a register setting or other indication) to either utilize the redundant columns in the second portion to replace any defective columns in the first portion or not. Accordingly, the processing logic can read this indication to determine the configuration of the memory device 130.

Responsive to determining that the memory device 130 is in the column replacement mode, at operation 415, the processing logic replaces the defective columns in the first portion with redundant columns from the second portion. In one embodiment, each memory device includes a set of redundant bitlines that are not normally used to store data. By replacing the defective columns with redundant bitlines (e.g., by logically remapping the memory addresses associated with the defective columns to the redundant bitlines), properties and capabilities of the memory device can be improved.

At operation 420, the processing logic configures the remaining redundant columns from the second portion to store parity data for codewords in the first portion with continuous codeword addressing. Each codeword stored in memory cells associated with columns in the first portion of the memory array includes a data portion (e.g., 4 KB) and a parity portion (e.g., 200 B). An extra parity portion corresponding to each codeword can be stored at memory cells associated with the unused redundant columns from the second portion of the memory array. Although this extra parity portion is physically separated from the data portion and the parity portion, the processing logic can modify the logical addressing scheme so that the data portion, the parity portion and the extra parity portion are part of a continuous address range. The extra parity portion can improve the error correction capability of the memory device, which leads to fewer errors and increased read window budget.

Responsive to determining that the memory device 130 is not in the column replacement mode, at operation 425, the processing logic determines the location of the defective columns in the first portion of the memory array. When the memory device 130 is not in the column replacement mode, the defective columns in the first portion are not replaced with redundant columns in the second portion, thus making all of the columns in the second portion available to store extra parity data for codewords in the first portion. In one embodiment, property and capability improvement component 213 sends a command/request to memory device 130, and receives in response, an indication of which columns are defective (e.g., unique identifiers) and their corresponding locations.

At operation 430, the processing logic configures the memory devices to perform an erasure decoding operation based on the determined location of the defective columns. Erasure decoding, in error correcting codes, is a technique used to recover missing data in scenarios where certain data elements or symbols are lost or become unreadable, but the remaining information can still be used to reconstruct the missing parts. The log-likelihood ratio (LLR) is one metric used in erasure decoding algorithms to estimate the likelihood of different symbols or bits being either ‘0’ or ‘1’. LLRs play a significant role in determining the most probable values for the erased or missing data, thus facilitating the reconstruction process. In the erasure decoding process, the received symbols in the codeword are classified as either erasures or non-erasures based on the knowledge of which symbols are lost or unreadable (e.g., those symbols associated with the location of the defective columns). The LLRs are calculated and propagated through the decoding algorithm to estimate the most likely values for the erased symbols. In one embodiment, the algorithm utilizes the available LLRs from the non-erased symbols to make informed decisions about the values of the erased symbols.

After either operation 420, or operation 430, at operation 435, the processing logic reanalyzes the property and capability characteristics of the memory device and determines whether the property and capability characteristics meet the standards associated with a different use case. In one embodiment, property and capability improvement component 213 notifies processing logic 160 that at least a portion the redundant columns are storing extra parity data, thereby increasing the error correction capability. As described above, the processing logic 160 can analyze the property and capability characteristics of the memory device 130 such as by performing any appropriate measurements, tests, scans, or other analyses to determine one or more representative property and capability characteristics of the memory device 130 after the redundant columns have been utilized.

If the property and capability characteristics meet the standards associated with a different use case, at operation 440, the processing logic associates the memory device with a group corresponding to the different use case. In one embodiment, the utilization of the redundant columns can lead to an increase in the property and capability characteristics (e.g., RWB) of the memory device 130, such that the property and capability characteristics can now meet a higher threshold level. For example, if the property and capability characteristics were previously below the threshold level 193, thus putting the memory device in bin 1 192 associated with use case 1 182, the improved property and capability characteristics may be above the threshold level 193, which is the minimum standard of property and capability characteristics for use case 2 184. Accordingly, the processing logic 160 can instead associate the memory device 130 with bin 2 194 corresponding to use case 2 184. If the property and capability characteristics do not meet the standards associated with a different use case, at operation 445, the processing logic maintains the memory device in a current group of memory devices corresponding to a given use case.

FIG. 5 is a flow diagram of an example method of utilizing adaptive media scan thresholds to improve the latent read disturb tolerance in a memory sub-system in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by property and capability improvement component 213 of FIG. 2 in response to configuration by processing logic 106 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 505, the processing logic (e.g., property and capability improvement component 213) identifies the latent read disturb margin in a memory device, such as memory device 130. For example, in response to configuration commands/instructions received from processing logic 106, property and capability improvement component 213 can perform an analysis to identify the latent read disturb margin. In one embodiment, each memory device has a potentially different capability to endure the latent read disturb stress to a certain degree. This capability can be measured in terms of the read window budget mentioned described above, after the latent read disturb stress is applied. The latent read disturb stress can be associated with a repeated read operation on the same block of a memory device with a short period of time, such as 10 second range, for example, for a longer period of time, such as several days.

At operation 510, the processing logic determines whether the latent read disturb margin satisfies a threshold criterion. For example, property and capability improvement component 213 can determine whether the latent read disturb margin is less than or equal to a threshold amount. In one embodiment, the threshold criterion is satisfied if the latent read disturb margin is less than or equal to the threshold amount.

Responsive to determining that the latent read disturb margin satisfies the threshold criterion, at operation 515, the processing logic maintains the memory device in a current group of memory devices corresponding to a given use case. Since the latent read disturb margin in the memory device is relatively low, there are not significant gains to be made in the property and capability characteristics of the memory device by modifying a media scan frequency. In one embodiment, property and capability improvement component 213 provides an indication that the latent read disturb margin satisfies the threshold criterion to the processing logic 106, which can determine to maintain the memory device in the current group (e.g., in bin 1 192 corresponding to use case 1 182).

If however, the latent read disturb margin does not satisfy the threshold criterion, at operation 520, the processing logic modifies a media scan frequency for the memory device 130. In one embodiment, the latent read disturb margin does not satisfy the threshold criterion if the latent read disturb margin is greater than the threshold amount. Since the latent read disturb margin in the memory device is relatively high, there can be significant gains to be made in the property and capability characteristics of the memory device by modifying the media scan frequency. Latent read disturb stress can occur when periodic read operations are repeatedly performed on the memory device 130. To manage this stress a media scan operation can be periodically performed to scan the data, and if sufficient risk is detected, relocate the data to another location on the same or a different memory device. Such media scans while beneficial in prevent data loss, do involve some latency that hurts memory device performance. When the latent read disturb margin in a given memory device is higher, there is less risk of data loss due to latent read disturb stress, thus allowing media scans to safely be performed less frequently. Thus, in one embodiment, property and capability improvement component 213 can reduce the frequency with which the media scan is performed (i.e., by increasing the interval between media scans), in order to improve memory device performance.

At operation 425, the processing logic reanalyzes the property and capability characteristics of the memory device and determines whether the property and capability characteristics meet the standards associated with a different use case. In one embodiment, property and capability improvement component 213 notifies processing logic 160 that media scan frequency has been modified. As described above, the processing logic 160 can analyze the property and capability characteristics of the memory device 130 such as by performing any appropriate measurements, tests, scans, or other analyses to determine one or more representative property and capability characteristics of the memory device 130 after the media scan frequency has been modified.

If the property and capability characteristics meet the standards associated with a different use case, at operation 530, the processing logic associates the memory device with a group corresponding to the different use case. In one embodiment, the modification of the media scan frequency can lead to an increase in the property and capability characteristics of the memory device 130, such that the property and capability characteristics can now meet a higher threshold level. For example, if the property and capability characteristics were previously below the threshold level 193, thus putting the memory device in bin 1 192 associated with use case 1 182, the improved property and capability characteristics may be above the threshold level 193, which is the minimum standard of property and capability characteristics for use case 2 184. Accordingly, the processing logic 160 can instead associate the memory device 130 with bin 2 194 corresponding to use case 2 184.

Depending on the implementation, there can be a number of system features that can be utilized instead of or in addition to the redundant columns and the adaptive media scan approaches described above. For example, processing logic 160 can configure property and capability improvement component 213 to utilize adaptive wear leveling based on die-level endurance information to improve memory device endurance, to utilize a modified media scan frequency based on data retention capability to improve memory device data retention, to utilize a modified read disturb scan and block folding frequency based on die-level read disturb capability to improve memory device read disturb tolerance, or to adaptively trim certain parameters based on die information to improve memory access operation performance (e.g., during read, program, and/or erase operations). Depending on the implementation, processing logic 160 can configure property and capability improvement component 213 to utilize two or more of these system features together. As such, the system features are not mutually exclusive and can be used together to improve the property and capability characteristics of the memory device 130 and the memory sub-system 210.

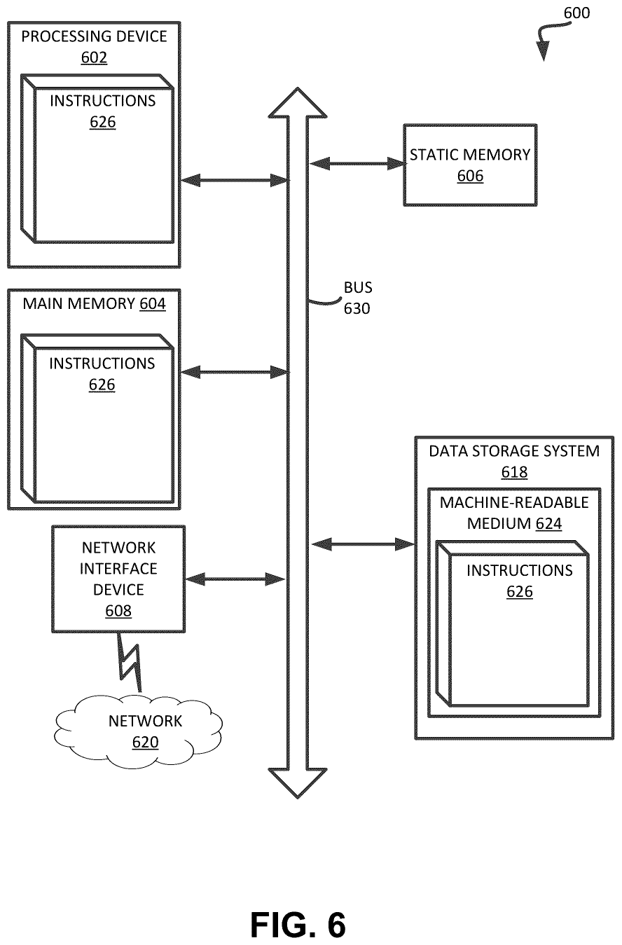

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 220 of FIG. 2) that includes, is coupled to, or utilizes a memory sub-system (e.g., the memory sub-system 220 of FIG. 2) or can be used to perform the operations of a controller (e.g., to execute an operating system to perform operations corresponding to the property and capability improvement component 213 of FIG. 2). In other embodiments, the computer system 600 can correspond to a processing system implementing processing logic 160 of FIG. 1A. In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 210 of FIG. 2.

In one embodiment, the instructions 626 include instructions to implement functionality corresponding to the processing logic 106 of FIG. 1 or the property and capability improvement component 213 of FIG. 2. While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device development system to execute a development process to produce a plurality of memory devices; and
a processing device, operatively coupled with the memory device development system, to perform operations comprising:
analyzing one or more property and capability characteristics of the plurality of memory devices produced in the development process;
identifying respective subsets of the plurality of memory devices having property and capability characteristics that meet respective standards associated with a plurality of different use cases; and
allocating the respective subsets to groups of memory devices corresponding to the different use cases.

2. The system of claim 1, wherein the one or more property and capability characteristics comprise a read window budget (RWB) of the plurality of memory devices.

3. The system of claim 1, wherein the one or more property and capability characteristics comprise one or more of endurance, data retention capability, read disturb tolerance, latent read disturb tolerance, a number of blocks/pages available to a user, or a number of bitlines/columns available to the user of the plurality of memory devices.

4. The system of claim 1, wherein the respective standards associated with the plurality of different use cases comprise a respective minimum level of properties and capabilities associated with each of the plurality of different uses cases.

5. The system of claim 1, wherein the plurality of different uses cases comprise one or more of client systems, mobile applications, enterprise data centers, automotive applications, industry systems, or removable storage devices.

6. The system of claim 1, wherein the development process comprises a plurality of stages, and wherein memory devices produced at each stage have improved property and capability characteristics relative to a previous stage.

7. The system of claim 1, wherein the processing device is to perform operations further comprising:
configuring a memory sub-system controller of a memory sub-system comprising one or more of the plurality of memory devices to utilize one or more redundant bitlines of the one or more of the plurality of memory devices to store additional parity data.

8. The system of claim 1, wherein the processing device is to perform operations further comprising:
configuring a memory sub-system controller of a memory sub-system comprising one or more of the plurality of memory devices to utilize an adaptive media scan threshold for the one or more of the plurality of memory devices.

9. A method comprising:
analyzing one or more property and capability characteristics of a plurality of memory devices produced in a development process executed by a memory device development system;
identifying respective subsets of the plurality of memory devices having property and capability characteristics that meet respective standards associated with a plurality of different use cases; and
allocating the respective subsets to groups of memory devices corresponding to the different use cases.

10. The method of claim 9, wherein the one or more property and capability characteristics comprise a read window budget (RWB) of the plurality of memory devices.

11. The method of claim 9, wherein the one or more property and capability characteristics comprise one or more of endurance, data retention capability, read disturb tolerance, latent read disturb tolerance, a number of blocks/pages available to a user, or a number of bitlines/columns available to the user of the plurality of memory devices.

12. The method of claim 9, wherein the respective standards associated with the plurality of different use cases comprise a respective minimum level of properties and capabilities associated with each of the plurality of different uses cases.

13. The method of claim 9, wherein the plurality of different uses cases comprise one or more of client systems, mobile applications, enterprise data centers, automotive applications, industry systems, or removable storage devices.

14. The method of claim 9, wherein the development process comprises a plurality of stages, and wherein memory devices produced at each stage have improved property and capability characteristics relative to a previous stage.

15. The method of claim 9, further comprising:
configuring a memory sub-system controller of a memory sub-system comprising one or more of the plurality of memory devices to utilize one or more redundant bitlines of the one or more of the plurality of memory devices to store additional parity data.

16. The method of claim 9, further comprising:
configuring a memory sub-system controller of a memory sub-system comprising one or more of the plurality of memory devices to utilize an adaptive media scan threshold for the one or more of the plurality of memory devices.

17. A non-transitory computer-readable storage medium comprising instructions that, when executed by a processing device, cause the processing device to perform operations comprising:
analyzing one or more property and capability characteristics of a plurality of memory devices produced in a development process executed by a memory device development system;
identifying respective subsets of the plurality of memory devices having property and capability characteristics that meet respective standards associated with a plurality of different use cases; and
allocating the respective subsets to groups of memory devices corresponding to the different use cases.

18. The non-transitory computer-readable storage medium of claim 17, wherein the respective standards associated with the plurality of different use cases comprise a respective minimum level of properties and capabilities associated with each of the plurality of different uses cases, and wherein the plurality of different uses cases comprise one or more of client systems, mobile applications, enterprise data centers, automotive applications, industry systems, or removable storage devices.

19. The non-transitory computer-readable storage medium of claim 17, wherein the instructions cause the processing device to perform operations further comprising:
configuring a memory sub-system controller of a memory sub-system comprising one or more of the plurality of memory devices to utilize one or more redundant bitlines of the one or more of the plurality of memory devices to store additional parity data.

20. The non-transitory computer-readable storage medium of claim 17, wherein the instructions cause the processing device to perform operations further comprising:
configuring a memory sub-system controller of a memory sub-system comprising one or more of the plurality of memory devices to utilize an adaptive media scan threshold for the one or more of the plurality of memory devices.
